(19) United States
(12) Patent Application Publication
(10) Pub. No.: US 2008/0148306 A1
(43) Pub. Date: Jun. 19, 2008

(54) System For Managing Bandwidth

(76) Inventor: William Mutual, Vancouver (CA)

Correspondence Address: Paul D. Gornall;Reg'd Patent & TM Agent, 1820 -- 355 Burrard St., Vancouver, V6C 2G8, omitted

(21) Appl. No.: 11/816,170

(22) PCT Filed: Feb. 10, 2006
(86) PCT No.: PCT/IB06/00263

§ 371 Date: Aug. 13, 2007

(30) Foreign Application Priority Data
Feb. 14, 2005 (SG) 200500797-6

(51) Int. Cl. H04N 7/173; H04N 7/16

(52) U.S. Cl. 725/1; 725/114

(57) ABSTRACT

A system (10) for managing bandwidth for delivering webcasts from webcasters (50) to viewers (40), the system (10) comprising: a booking module (20) to receive webcast bookings from the webcasters (50), each booking defining technical and operational requirements for the webcast, the technical requirements including transmission speed of the webcast, number of expected viewers (40), and duration of the webcast, and the operational requirements including secure access for viewers (40) and digital rights management; a processing module (21) to automatically compute the available bandwidth based on the technical requirements for the webcast; and a monitoring module (22) to continuously monitor the available bandwidth to be offered for sale for other webcasts.

### TECHNICAL FIELD

The invention concerns a system for managing bandwidth for delivering webcasts from webcasters to viewers.

### BACKGROUND INFORMATION

“Webcasting” describes the activity of using the Internet to deliver in real-time live or delayed versions of sound or video broadcasts. Webcasting may also include delayed or preview versions of movies, music videos, or regular radio and television broadcasts as a way to promote the live broadcasts. Viewing webcasts requires having an appropriate video viewing application such as the WindowsMedia, Real Video, or QuickTime streaming video players; these can usually be downloaded from any site offering a webcast.

Technically speaking, a webcast that is being viewed live is a form of push technology. Live webcasts are controlled by the content provider, sponsor or webcaster and occur at a specific time. Information is pushed by the sender to a group of receivers over the Internet who concurrently all view the same content (which is somewhat similar to how a traditional TV broadcast channel works). In contrast to a live webcast is video-on-demand, which is a form of pull technology. Video-on-demand allows a web site visitor to download and experience audio and video content as they desire. The audio or video content may be streamed or downloaded in full before playback can occur.

Bandwidth costs are one of the largest operating costs for a webcaster. Therefore maximizing the efficiency of bandwidth usage is highly desirable.

### SUMMARY OF THE INVENTION

In a first preferred aspect, there is provided a system for managing bandwidth for delivering webcasts from webcasters to viewers, the system comprising:
a booking module to receive webcast bookings from the webcasters, each booking defining technical and operational requirements for the webcast, the technical requirements including transmission speed of the webcast, number of expected viewers, and duration of the webcast, and the operational requirements including secure access for viewers and digital rights management;
a processing module to automatically compute the available bandwidth based on the technical requirements for the webcast; and
a monitoring module to continuously monitor the available bandwidth to be offered for sale to other webcasts.

Advantageously, webcasters are able to input the conditions of their webcast (including date, scheduling, notifications to viewers, determination of viewer permissions and any restrictions, payment requirements and other related criteria). These conditions are combined with the bandwidth management abilities to provide the webcaster with an automated system for their specific Internet broadcasting needs.

Another advantage of at least one embodiment of the present invention is a concordant ability to maximize the efficiency of streaming servers and their related networking hardware.

The system may further comprise a billing module to bill the webcasters for bandwidth usage.

The system may further comprise an integration module to integrate a webcaster's contact list to extract the viewers for the webcast.

The system may further comprise a link generation module to automatically generate links to enable a viewer to launch the webcast according to the operational requirements.

If the webcast contains live content, the system may further comprise a scheduling module to record the webcast for archiving according to the operational requirements.

The webcast may be live content.

The webcast may originate from a mobile telephone, mobile computer, personal digital assistant (PDA), or webcasting computer console.

In a second aspect, there is provided a method for managing bandwidth for delivering webcasts from webcasters to viewers, the method comprising:
requesting a webcast booking to define technical and operational requirements for the webcast, the technical requirements including transmission speed of the webcast, number of expected viewers, and duration of the webcast, and the operational requirements including secure access for viewers and digital rights management;
automatically computing the available bandwidth based on the technical requirements for the webcast; and
continuously monitoring the available bandwidth to be offered for sale for other webcasts.

### BRIEF DESCRIPTION OF THE DRAWINGS

An example of the invention will now be described with reference to the accompanying drawings, in which:

FIG. 1 is a block diagram of the management system for webcasts; and

FIG. 2 is a process flow diagram of managing bandwidth for webcasts.

### DETAILED DESCRIPTION OF THE DRAWINGS

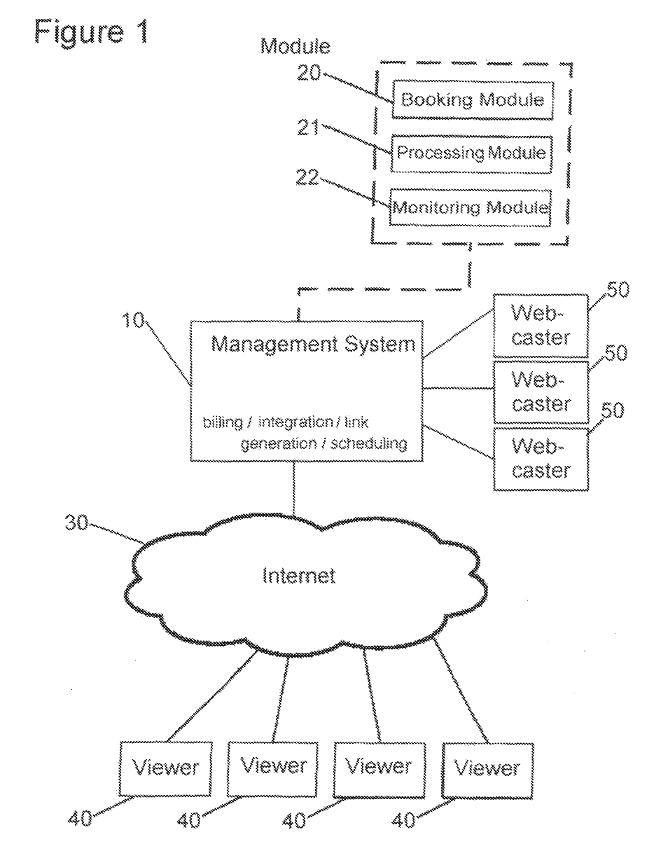

FIG. 1 and the following discussion are intended to provide a brief, general description of a suitable computing environment in which the present invention may be implemented. Although not required, the invention will be described in the general context of computer-executable instructions, such as program modules, being executed by a personal computer. Generally, program modules include routines, programs, characters, components, data structures, that perform particular tasks or implement particular abstract data types. As those skilled in the art will appreciate, the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring to FIG. 1, a management system 10 for managing bandwidth for delivering webcasts from webcasters 50 to viewers 40 is provided. The webcast may be live content or pre-recorded content. The webcast originates from a mobile telephone or webcasting computer console. The system 10 generally comprises a booking module 20, a processing module 21 and a monitoring module 22. The booking module 20 receives webcast bookings from the webcasters 50. The webcasters 50 enter and complete their bookings via web-based form. Each booking defines technical and operational requirements for the webcast. The technical requirements include transmission speed of the webcast, number of expected viewers 40, and duration of the webcast. The operational requirements include username/password authentication for viewers 40, digital rights management and IP access restriction. The processing module 21 automatically computes the available bandwidth based on the technical requirements for the webcast. The monitoring module 22 continuously monitors the available bandwidth to be offered for sale for other webcasts.

The system 10 is embodied in software and installed on a server computer (not shown). The server is connected to the Internet 30 to deliver webcasts to the computers of the viewers 40.

Using the technical requirements, the total amount of bandwidth is determined to service a particular webcast. The total amount of bandwidth determined is subtracted from the total overall amount of available bandwidth to be sold for the same time period. The webcaster 50 is charged an appropriate bandwidth usage fee for bandwidth usage.

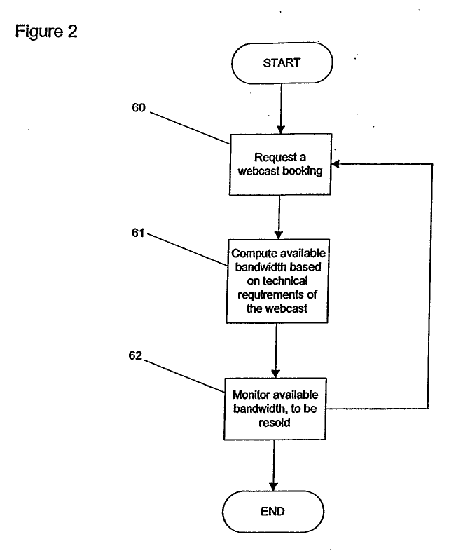

Referring to FIG. 2, for example, a webcaster 50 wants to make a webcast booking so that 100 people are able to watch his 400 kilobyte/second webcast. The webcaster 50 requests 60 a webcast booking. The webcast transmission will start at 8 PM GMT and end one hour later. The bandwidth required for this webcast is calculated 61 as follows:
100 people×400 kb/sec×60 seconds×60 minutes=144,000,000 kilobytes (18 GB of data). This computation 61 is performed automatically by extracting the webcast details from the booking.

The webcaster 50 is charged for 18 GB of data. Next, the 100×400 kb/sec (40 Mb/sec) of bandwidth capacity is subtracted from the total overall available bandwidth. The remaining bandwidth is available for re-selling during the one-hour webcast, for use for another webcast(s). The remaining bandwidth is continuously monitored 62 such that the amount of bandwidth available for re-selling is known for any point in time.

The ability to monitor and resell bandwidth on a continuous basis provides for “bandwidth exchange” abilities. Since the cost of bandwidth is a primary expenditure for a Webcast service provider/operator, the system 10 provides efficient automated reselling of bandwidth and server resources. The service provider/operator functions similarly to an third party application service provider (ASP).

The system 10 operates efficiently by offering simple integration with a webcaster's 50 existing contact base via an integration module (not shown). The webcaster may store all their potential viewers' 40 details in their contact list, or instant messaging buddy list. The webcaster 50 is also able to manually add new viewers 40 to their contact base.

The system 10 also has a link generation module (not shown) to automatically generate links to enable a viewer 40 to launch the webcast according to the operational requirements. The links may be Universal Resource Locator (URL) links to direct the viewer 40 directly to the IP address and path of the webcast. The links may also be encrypted or otherwise disguised in order to help enforce a viewing by only the webcasters permitted and expected audience. If the webcast is going to be a live broadcast, the system 10 has a scheduling module (not shown) to a) allow for advance notification to the invited viewers, and b) to enable the recording of the live webcast for automated archiving according to the operational requirements.

In one embodiment, the system 10 is embodied in a content streaming network. This network comprises a master-streaming server connected to a plurality of regional streaming servers. Multiple viewers may be connected to each regional streaming server in order to receive the webcast as is originally sourced from the master streaming server. The system utilizes a proprietary open shortest path first (OSPF) algorithm in order to determine which streaming server would likely provide the optimal quality of delivery to the viewer. The algorithm utilizes a combination of “hop counting”, ping delivery response time and streaming server load within its analysis. The determined server is then compared against the available bandwidth resources at that particular server. If all available bandwidth resources are allocated, the algorithm is recalibrated to recompute the next best server (from the remaining pool of available regional streaming servers). This server analysis server topology allocates the overall bandwidth resources so that they are efficiently used by the viewers, resulting in improved quality of service delivery of the Webcast data. The regional streaming servers may have varied bandwidth capacity from each other to specific viewers. Thus, the selection of the optimal regional streaming server(s) for a specific viewer or group of viewers is performed by determining the aggregate bandwidth amount available (with automated determination of costing and billing).

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

I Claim:

1. A system for managing bandwidth resources for delivering webcasts from webcasters to viewers, comprising:
a) booking module to receive webcast bookings from the webcasters, each booking defining technical requirements and operational requirements for a webcast;
i) the technical requirements including transmission speed of the webcast, number of expected viewers, and duration of the webcast; and
ii) the operational requirements including secure access for viewers and digital rights management;
b) a processing module to automatically compute total bandwidth resources needed for the webcast and remaining available bandwidth resources based on the technical requirements for the webcast; and
c) a monitoring module to monitor continuously during the webcast the available bandwidth resources that could be used for other webcasts.

2. The system according to claim 1, further comprising a billing module to bill the webcasters for bandwidth usage

3. The system according to claim 1 , further comprising an integration module to integrate a webcaster's contact list to extract the viewers for the webcast.

4. The system according to claim 1, further comprising a link generation module to automatically generate links to enable a viewer to launch the webcast according to the operational requirements.

5. The system according to claim 1, wherein the webcast is live content.

6. The system according to claim 5, further comprising a scheduling module to optionally permit recording of the webcast for archiving according to the operational requirements.

7. The system according to claim 6, wherein the webcast originates from a mobile telephone, mobile computer, personal digital assistant (PDA), or webcasting computer console.

8. (canceled)

9. The system according to claim 1, in which the available bandwidth is continuously offered for re-selling for other webcasts.

10. The system according to claim 1, in which the system accepts input from the webcaster additional conditions of a webcast, to be combined with bandwidth resource management, the additional conditions including at least one of date, scheduling, notifications to viewers, determination of viewer permissions, restrictions, payment requirements.

11. The system according to claim 2, in which
a) an integration module integrates a webcaster's contact list to extract the viewers for the webcast;
b) a link generation module automatically generates links to enable a viewer to launch the webcast according to the operational requirements;
c) the webcast is live content;
d) a scheduling module optionally permits recording of the webcast for archiving according to the operational requirements;
e) the webcast originates from a mobile telephone, mobile computer, personal digital assistant (PDA), or webcasting computer console;
f) the available bandwidth is continuously offered for re-sale for other webcasts;
g) in which the system accepts input from the webcaster additional conditions of a webcast, to be combined with bandwidth resource management, the additional conditions including at least one of date, scheduling, notifications to viewers, determination of viewer permissions, restrictions, payment requirements.
